(19) United States
(12) Patent Application Publication
(10) Pub. No.: US 2026/0119838 A1
(43) Pub. Date: Apr. 30, 2026

(54) SCALABLE AI USING MIXTURE OF EXPERTS

(71) Applicant: Toyota Motor Engineering & Manufacturing North America, Inc., Plano, TX (US)

(72) Inventors: Alexander T. Pham, San Jose, CA (US); Pedram Akbarian Saravi, Austin, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/931,697

(22) Filed: Oct. 30, 2024

(51) Int. Cl. G06N 3/0455

(52) U.S. Cl. CPC G06N 3/0455

(57) ABSTRACT

Systems, methods, and other embodiments described herein relate to improving predictions from time-series data using a unique network architecture. In one embodiment, a method includes acquiring input data about operating characteristics of a device, the input data being time-series data. The method includes encoding the input data by i) autocorrelating the input data and ii) applying an encoder mixture of experts (MoE) layer to generate a feature vector. The method includes decoding the feature vector by i) autocorrelating the feature vector with an initialization query and ii) applying a decoder MoE layer to generate a prediction. The method includes providing the prediction.

### TECHNICAL FIELD

The subject matter described herein relates, in general, to using mixture of experts within a unique network architecture to process time-series data and, more particularly, to determining remaining useful life (RUL) of a battery using the unique network architecture.

### BACKGROUND

Machine-learning (ML) models are a powerful tool for processing data and making inferences. However, as with any technology, ML models encounter various difficulties. For example, in the interest of performance of a model, various tradeoffs are typically required, such as more complex/larger models, larger training datasets, additional training, and so on. These tradeoffs can represent significant computing costs that may not be practical for all applications. Moreover, many newly developed ML models are not well-suited for time-series data, which represents unique processing challenges.

For example, predicting when a device will fail is a complex and elusive task that often relies on time-series data (e.g., current and past operating characteristics). Batteries, such as lithium-ion batteries, are widely used in electric vehicles for energy storage. The performance of state-of-the-art lithium-ion batteries deteriorates with time and usage. Having accurate estimations of a remaining useful life (RUL) and being able to predict a future degradation rate is central when setting maintenance and warranty strategies. In particular, electric vehicle (EV) dealers and customers use this information to estimate the value of used EVs and determine the second-life (e.g., grid storage) applications for used batteries. The RUL of a battery is generally dependent on the usage history. For example, two one-year-old batteries manufactured from the same production line, with one being fast-charged and discharged daily for a 20-mile trip and another only getting operated once a year for a one-hundred-mile trip, show very different rates of capacity loss. However, available approaches for predicting battery RUL are generally limited by the ML models implemented to perform the prediction. As such, data storage and processing for such information can be burdensome when available.

### SUMMARY

Example systems and methods relate to a manner of improving predictions from time-series data using a unique network architecture. As previously noted, many approaches to analyzing time-series data can suffer from difficulties associated with computing costs and/or accuracy. That is, in order to attain an adequate level of accuracy, a model may need to be trained with a large dataset having a wide variety of examples. While this may seem reasonable from a high-level view, in practice, acquiring such data and performing the training can be a significant burden. Even still, when the data itself is time-series data, i.e., data about events over time, the model may still not provide the desired level of accuracy because of complications from the nature of the data itself. For example, in relation to the prediction of remaining useful life (RUL) for batteries or other devices, a variation of five percent may result in an unexpected early failure of the battery.

Therefore, in at least one approach, a unique network architecture for a machine-learning model is disclosed. The architecture is, for example, a transformer-based architecture that implements a mixture of experts (MoE) layer in place of conventional feed forward networks. The MoE itself is comprised of a plurality of different “experts,” which are separate networks, referred to as learners, that are best-suited or expert for a particular input. The MoE layer further includes a gating network that routes input tokens to the separate experts according to characteristics of the tokens. By providing the separate experts, the MoE layer is able to scale in a more efficient manner than a traditional feed-forward network, thereby improving the network size and training by avoiding unduly extensive networks for the task. Moreover, in at least one arrangement, the MoE is optimized to improve the routing of tokens to different experts. For example, the disclosed system may train the gating network through a process that normalizes the inputs. Normalizing the input to the gating network during training stabilizes and thereby improves the training of the gating network to ultimately improve the functioning of the MoE layer. Accordingly, the presently described architecture implements this MoE layer to improve overall performance.

As an overview consider that the system acquires input data about operation of a device, such as a battery. The input data is, for example, time-series data that that may include voltage, temperature, cycles, and other attributes that characterize the capacity of the battery. In any case, the model is comprised of multiple components, including an encoder and a decoder. The encoder further comprises separate sub-components that perform separate functions. In at least one arrangement, the encoder includes, in processing sequence, an autocorrelation block, a decomposition block, an encoder MoE layer, and an additional decomposition block.

The autocorrelation block functions to, for example, determine period-based dependencies by calculating a series autocorrelation and aggregating similar sub-series by time delay aggregation. That is, the autocorrelation block analyzes the input data to identify correlations across time within the input data. Thus, the autocorrelation block facilitates understanding patterns in time. The decomposition block acquires the output of the autocorrelation block and decomposes the output into seasonal and trend components. The seasonal component reflects the seasonality of the input data, i.e., the periodic/seasonal patterns in the input data. By contrast, the trend reflects the long-term progression of the pattern within the input data.

In any case, the encoder MoE layer accepts the decomposed data processed from the autocorrelation block and determines patterns between features irrespective of the time. Thus, the autocorrelation block determines time-dependent patterns while the MoE layer determines feature-dependent patterns, which are output as a feature vector. The encoder can further include an additional decomposition back after the MoE layer that decomposes the output of the MoE layer since the MoE layer generally compresses the information into a feature vector.

This output is provided to the decoder of the architecture. However, the decoder also accepts initialization data in the form of a seasonal initialization component and a trend initialization component. The initialization data generally includes a portion of the original input data (e.g., a most recent section) along with a placeholder for a future time associated with the prediction. The decoder includes an initialization block that accepts the initialization data and includes an autocorrelation block and a decomposition block. A further autocorrelation block of the decoder accepts an output of the decomposition block, which then feeds into a decomposition block. The output of the decomposition block feeds to a decoder MoE layer, which in turn feeds into an additional decomposition block. Ultimately, the output is accumulated with the trend data from the initialization and intermediate outputs to provide the prediction. The prediction is, in the instant example, a remaining useful life (RUL) of the battery. In this way, the distinct architecture of the present approach overcomes the noted difficulties and provides an improved approach to generating the prediction.

In one embodiment, a prediction system is disclosed. The prediction system includes one or more processors and a memory communicably coupled to the one or more processors. The memory stores instructions that, when executed by the one or more processors, cause the one or more processors to acquire input data about operating characteristics of a device, the input data being time-series data. The instructions include instructions to encode the input data by i) autocorrelating the input data and ii) applying an encoder mixture of experts (MoE) layer to generate a feature vector. The instructions include instructions to decode the feature vector by i) autocorrelating the feature vector with an initialization query and ii) applying a decoder MoE layer to generate a prediction. The instructions include instructions to provide the prediction about the device.

In one embodiment, a non-transitory computer-readable medium including instructions that, when executed by one or more processors, cause the one or more processors to perform one or more functions is disclosed. The instructions include instructions to acquire input data about operating characteristics of a device, the input data being time-series data. The instructions include instructions to encode the input data by i) autocorrelating the input data and ii) applying an encoder mixture of experts (MoE) layer to generate a feature vector. The instructions include instructions to decode the feature vector by i) autocorrelating the feature vector with an initialization query and ii) applying a decoder MoE layer to generate a prediction. The instructions include instructions to provide the prediction about the device.

In one embodiment, a method is disclosed. In one embodiment, the method includes acquiring input data about operating characteristics of a device, the input data being time-series data. The method includes encoding the input data by i) autocorrelating the input data and ii) applying an encoder mixture of experts (MoE) layer to generate a feature vector. The method includes decoding the feature vector by i) autocorrelating the feature vector with an initialization query and ii) applying a decoder MoE layer to generate a prediction. The method includes providing the prediction.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a prediction system that is associated with improving predictions of remaining useful life for a device from time-series data using a unique network architecture.

FIG. 2 illustrates one embodiment of the detection system of FIG. 2 in a cloud-computing environment.

FIG. 3 illustrates one embodiment of a model having a unique network architecture to facilitate processing time-series data.

FIG. 4 illustrates an example of a mixture of experts (MoE) layer.

FIG. 5 illustrates a flowchart for one embodiment of a method that is associated with improving predictions of remaining useful life (RUL) from time-series data.

FIG. 6 illustrates one embodiment of a vehicle within which systems and methods disclosed herein may be implemented.

### DETAILED DESCRIPTION

Systems, methods, and other embodiments associated with improving predictions from time-series data using a unique network architecture. As previously noted, many approaches to analyzing time-series data can suffer from difficulties associated with computing costs and/or accuracy. That is, in order to attain an adequate level of accuracy, a model may need to be trained with a large dataset having a wide variety of examples. While this may seem reasonable from a high-level view, in practice, acquiring such data and performing the training can be a significant burden. Even still, when the data itself is time-series data, i.e., data about events over time, the model may still not provide the desired level of accuracy because of complications from the nature of the data itself. For example, in relation to the prediction of remaining useful life (RUL) for batteries or other devices, a variation of five percent may result in an unexpected early failure of the battery.

Therefore, in at least one approach, a unique network architecture for a machine-learning model is disclosed. The architecture is, for example, a transformer-based architecture that implements a mixture of experts (MoE) layer in place of conventional feed-forward networks. The MoE itself is comprised of a plurality of different “experts,” which are separate networks, referred to as learners, that are best-suited or expert for a particular input. The MoE layer further includes a gating network that routes input tokens to the separate experts according to characteristics of the tokens. By providing the separate experts, the MoE layer is able to scale in a more efficient manner than a traditional feed-forward network, thereby improving the network size and training by avoiding unduly extensive networks for the task. Moreover, in at least one arrangement, the MoE is optimized to improve the routing of tokens to different experts. For example, the disclosed system may train the gating network through a process that normalizes the inputs. Normalizing the input to the gating network during training stabilizes and thereby improves the training of the gating network to ultimately improve the functioning of the MoE layer. Accordingly, the presently described architecture implements this MoE layer to improve overall performance.

As an overview, consider that the system acquires input data about the operation of a device, such as a battery. The input data is, for example, time-series data that may include voltage, temperature, cycles, and other attributes that characterize the capacity of the battery. In any case, the model is comprised of multiple components, including an encoder and a decoder. The encoder is further comprised of separate sub-components that perform separate functions. In at least one arrangement, the encoder includes, in processing sequence, an autocorrelation block, a decomposition block, an encoder MoE layer, and an additional decomposition block.

The autocorrelation block functions to, for example, determine period-based dependencies by calculating a series autocorrelation and aggregating similar sub-series by time delay aggregation. That is, the autocorrelation block analyzes the input data to identify correlations across time within the input data. Thus, the autocorrelation block facilitates understanding patterns in time. The decomposition block acquires the output of the autocorrelation block and decomposes the output into seasonal and trend components. The seasonal component reflects the seasonality of the input data, i.e., the periodic/seasonal patterns in the input data. By contrast, the trend reflects the long-term progression of the pattern within the input data.

In any case, the encoder MoE layer accepts the decomposed data processed from the autocorrelation block and determines patterns between features irrespective of the time. Thus, the autocorrelation block determines time-dependent patterns while the MoE layer determines feature-dependent patterns, which are output as a feature vector. The encoder can further include an additional decomposition back after the MoE layer that decomposes the output of the MoE layer since the MoE layer generally compresses the information into a feature vector.

This output is provided to the decoder of the architecture. However, the decoder also accepts initialization data in the form of a seasonal initialization component and a trend initialization component. The initialization data generally includes a portion of the original input data (e.g., a most recent section) along with a placeholder for a future time associated with the prediction. The decoder includes an initialization block that accepts the initialization data and includes an autocorrelation block and a decomposition block. A further autocorrelation block of the decoder accepts an output of the decomposition block, which then feeds into a decomposition block. The output of the decomposition block feeds to a decoder MoE layer, which in turn feeds into an additional decomposition block. Ultimately, the output is accumulated with the trend data from the initialization and intermediate outputs to provide the prediction. The prediction is, in the instant example, a remaining useful life (RUL) of the battery. In this way, the distinct architecture of the present approach overcomes the noted difficulties and provides an improved approach to generating the prediction.

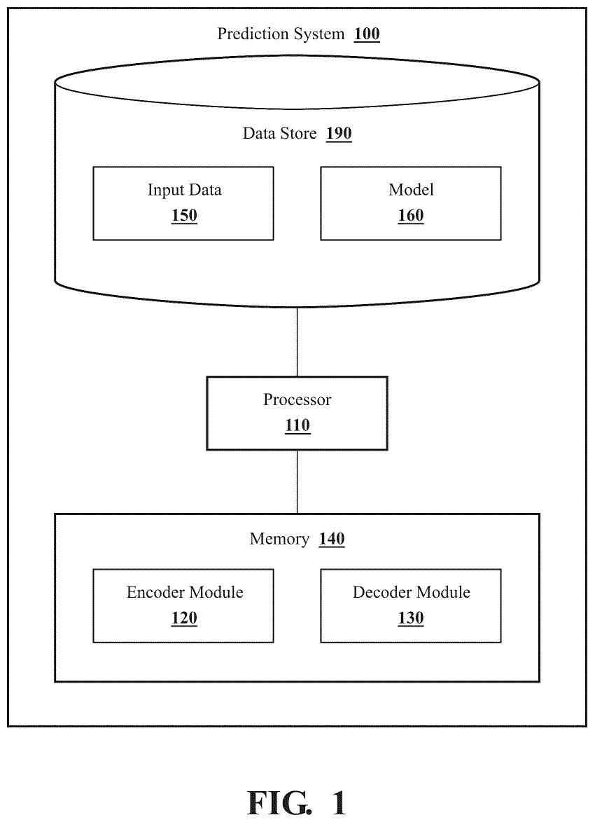

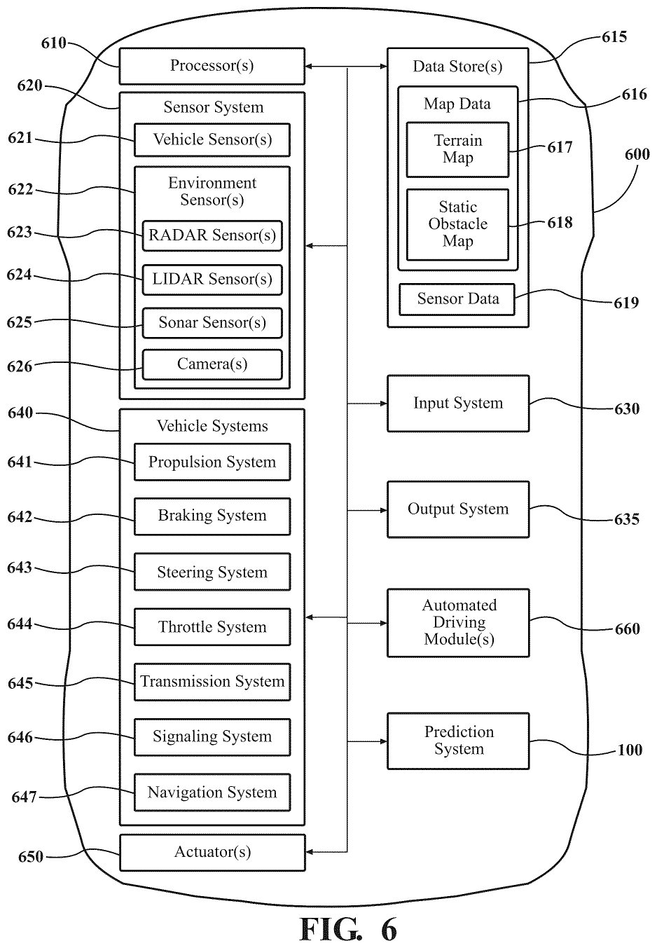

With reference to FIG. 1, one embodiment of a prediction system 100 is further illustrated. The prediction system 100 is shown as including a processor 110, which may be from a vehicle 600 (e.g., processor 610) of FIG. 6 or may be associated with a separate computing device, such as a server, cloud-computing system, and so on. Accordingly, the processor 110 may be a part of the prediction system 100, the prediction system 100 may include a separate processor from the processor 610 of the vehicle 600, or the prediction system 100 may access the processor 110 through a data bus or another communication path.

In one embodiment, the prediction system 100 includes a memory 140 that stores an encoder module 120 and a decoder module 130. The memory 140 is a random-access memory (RAM), read-only memory (ROM), a hard-disk drive, a flash memory, or another suitable memory for storing the modules 120 and 130. The modules 120 and 130 are, for example, computer-readable instructions that when executed by the processor 110 cause the processor 110 to perform the various functions disclosed herein. In alternative arrangements, the modules 120 and 130 are independent elements from the memory 140 that are, for example, comprised of hardware elements (e.g., arrangements of logic gates). Thus, the modules 120 and 130 are alternatively ASICS, hardware-based controllers, a composition of logic gates, or another hardware-based solution.

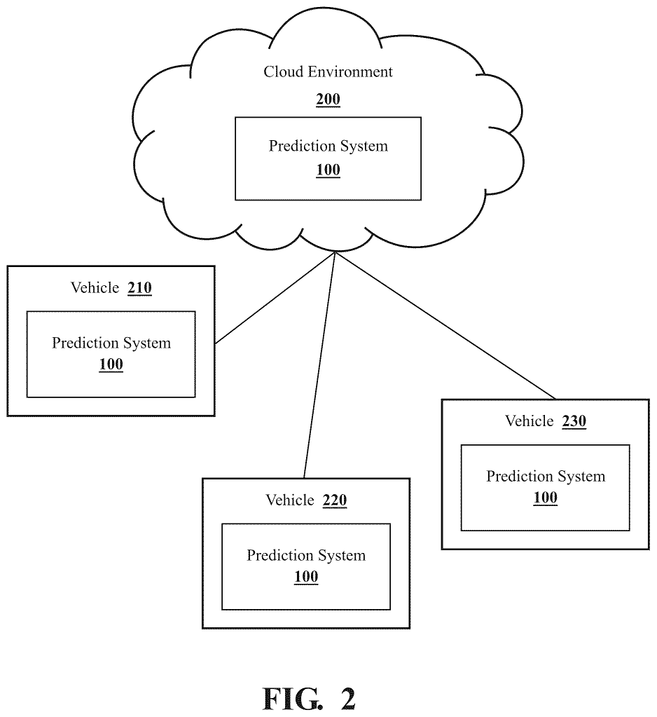

The prediction system 100, as illustrated in FIG. 1, is generally an abstracted form of the prediction system 100 as may be implemented between the vehicle 600 and a cloud-computing environment 200. FIG. 2 illustrates one example of a cloud-computing environment 200 that may be implemented along with the prediction system 100. As illustrated in FIG. 2, the prediction system 100 is embodied at least in part within the cloud-computing environment 200.

In one or more approaches, the cloud environment 200 may facilitate communications with multiple different vehicles 210, 220, and 230 to acquire information. Accordingly, as shown, the prediction system 100 may include separate instances within one or more entities of the cloud-based environment 200, such as servers, and also instances within vehicles 210, 220, and 230 that function cooperatively to acquire and analyze the noted information. In a further aspect, the entities that implement the prediction system 100 within the cloud-based environment 200 may vary beyond transportation-related devices and encompass mobile devices (e.g., smartphones), and other devices that may benefit from the functionality discussed herein. Thus, the set of entities that function in coordination with the cloud environment 200 may be varied.

In one approach, functionality associated with at least one module of the prediction system 100 is implemented within the vehicle 600, while further functionality is implemented within a cloud-based computing system. Thus, the prediction system 100 may include a local instance at the vehicle 600 and a remote instance that functions within the cloud-based environment. Of course, while discussed in a cloud context, in various arrangements, the prediction system 100 may be wholly implemented within a vehicle or within a cloud-based resource.

Moreover, the prediction system 100, as provided for herein, may function in cooperation with a communication system. In one embodiment, the communication system communicates according to one or more communication standards. For example, the communication system can include multiple different antennas/transceivers and/or other hardware elements for communicating at different frequencies and according to respective protocols. The communication system, in one arrangement, communicates via a communication protocol, such as a WiFi, DSRC, V2I, V2V, or another suitable protocol for communicating between the vehicle and other entities in the cloud environment. Moreover, the communication system, in one arrangement, further communicates according to a protocol, such as a global system for mobile communication (GSM), Enhanced Data Rates for GSM Evolution (EDGE), Long-Term Evolution (LTE), 5G, or another communication technology that provides for the vehicle communicating with various remote devices (e.g., a cloud-based server). In any case, the prediction system 100 can leverage various wireless communication technologies to provide communications to other entities, such as members of the cloud-computing environment.

With continued reference to FIG. 1, in one embodiment, the prediction system 100 includes the data store 170. The data store 170 is, in one embodiment, an electronic data structure stored in the memory 140 or another data storage device that is configured with routines that can be executed by the processor 110 for analyzing stored data, providing stored data, organizing stored data, and so on. Thus, in one embodiment, the data store 170 stores data used by the modules 120 and 130 in executing various functions. In one embodiment, the data store 170 stores the input data 150, the model 160 and/or other information used by the prediction system 100.

The encoder module 120 generally includes instructions that function to control the processor 110 to acquire data inputs that form the input data 150. In various arrangements, the input data 150 may be acquired from sensors associated with the device and/or a management system, such as a battery management system.

As provided for herein, the encoder module 120, in one embodiment, acquires the input data 150 that includes various information characterizing the operation of a device. For example, in at least one approach, the input data 150 includes information collected about the battery over a current cycle and/or prior cycles of the battery. The cycles are charge/discharge cycles that include, for example, a period of charging followed by a period of discharging. In general, the charge/discharge cycle can include discharging the battery of some capacity and charging the battery with added capacity. The values need not be the same nor extend to a whole capacity of the battery. In any case, the input data 150 can include values of, for example, voltage and current at an output of the battery over N prior cycles. Thus, the prediction system 100 may store the input data for the defined number of prior cycles N, while letting data prior to the N prior cycles expire. The N prior cycles can be selected per a particular implementation and may include, for example, 10 prior cycles of the battery. Moreover, while voltage and current are described, the input data 150 may include further information in other implementations, such as temperature, capacity, etc. In this way, the prediction system 100 functions to improve determinations about battery degradation/health. The input data 150 characterizes a discharge capacity of the battery at a given time and thus is generally indicative of the remaining useful life (RUL) of the battery at that time.

Accordingly, the prediction system 100, in one embodiment, controls the respective sensors to provide the data in the form of the input data 150 or at least receives the sensor data via one or more intermediaries therefrom. That is, the prediction system 100 may directly receive the input data 150 from sensors within the vehicle or may receive the input data 150 via a communication link. In either case, the input data 150 is time-series data (i.e., data about the operation of the battery over time) that generally characterizes at least a capacity.

The encoder module 120, in one embodiment, includes instructions that cause the processor 110 to initially acquire the input data 150 and then, in at least one approach, encode the input data 150 using the model 160. Additionally, the decoder module 130, in one embodiment, decodes an output from the encoder module 120 in order to provide a prediction of the remaining useful life (RUL) of the battery. The model 160 is, in at least one arrangement, a transformer-based neural network that implements an auto-correlation mechanism to discover the period-based dependencies and aggregate similar sub-series from underlying periods. Moreover, in place of a feed-forward network, the model 160 implements an MoE layer that functions to improve the efficiency of the model 160. In any case, the encoder module 120 and the decoder module 130 include instructions to implement separate components of the model 160.

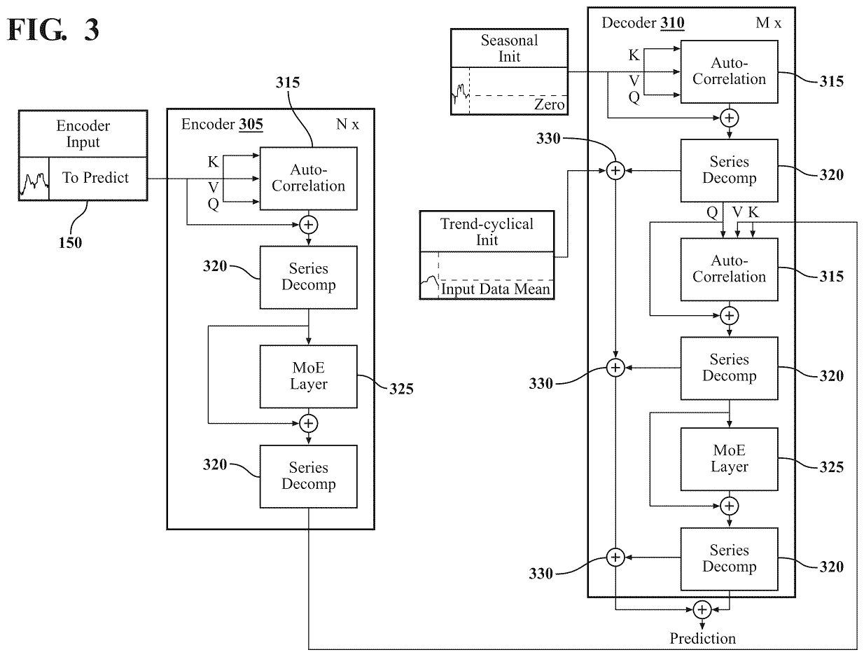

As further explanation of the model 160, consider FIG. 3, which shows a diagram 300 of one embodiment of the model 160, which is comprised of an encoder 305 and a decoder 310. As shown, the encoder 305 accepts the input data 150. The input data 150 is generally comprised of three separate components (K, V, and Q). K is the key, V is the value, and Q is the query. Within the encoder 305, the input data is fed into an autocorrelation block 315 while also being concatenated with an output of the autocorrelation block 315. The autocorrelation block 315 identifies the period-based dependencies by, for example, calculating a series autocorrelation and aggregating similar sub-series by time delay aggregation. In one approach, the autocorrelation block 315 implements a Fast Fourier Transform (FFT) to calculate the autocorrelation reflecting time-delay similarities. The autocorrelation block 315 can then roll the similar sub-processes to the same index based on a selected delay and aggregate them together as the output. In general, the autocorrelation performed by the model 160 provides a self-attention mechanism for series-wise connections. That is, the autocorrelation, for the temporal dependencies, finds the dependencies among sub-series based on the periodicity. Moreover, for the information aggregation, the autocorrelation block 315 adopts the time delay block to aggregate the similar sub-series from underlying periods.

The encoder 305 then concatenates the output of the block 315 with the original input data 150 and provides the intermediate result to a series decomposition block 320. The series decomposition block 320 decomposes the intermediate result into trend and seasonal components. The two components represent the long-term progression and the seasonality of the series, respectively. Thus, the series decomposition block 320 functions to extract the long-term stationary trend from predicted intermediate hidden variables progressively. In either case, the output is a decomposed set of values, including the trend-cyclical component and a seasonality component. This result is fed into an MoE layer 325 and also concatenated with an output of the MoE layer 325, as shown.

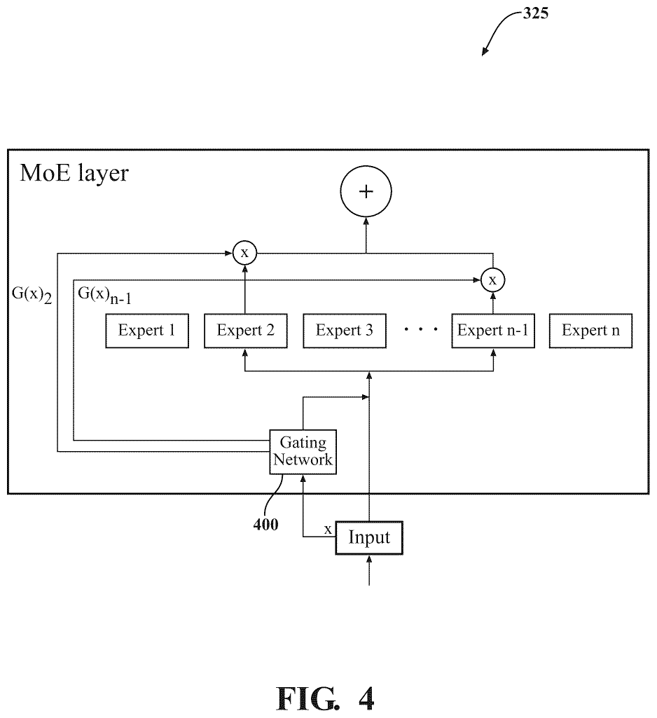

The MoE layer 325 itself functions to facilitate identifying patterns between features. That is, the MoE layer 325 derives feature dependencies that are output as a feature vector. As further detail of the structure of the MoE layer 325, consider FIG. 4. FIG. 4 illustrates a detailed view of the MoE layer 325. The MoE layer 325 is comprised of a gating network 400 and experts 410. The experts 410 are separate networks. For example, the experts 410 may be linear-ReLU networks, while the gating network 400 is, for example, a linear-ReLU SoftMax network. In any case, the MoE layer 325 performs conditional computation by activating only a part of the experts 410 for each input. In general, each distinct input to the MoE layer 325 may be comprised of two separate tokens. The gating network 400 analyzes each token and routes the token to a respective one of the experts 410. The separate experts 410 are “expert” in relation to a certain form of the input. That is, each expert is customized/specialized for a particular input to better process that type of input. As such, the gating network 400 is aware of the correlation between the inputs and the experts and is able to appropriately route the inputs so that only a subset of the experts are activated (i.e., one per token).

In at least one configuration, the prediction system 100 trains the gating network 400 how to route the tokens. For example, the prediction system 100 may implement a loss function or another feedback mechanism to train the gating network 400 how to best route the tokens to the different experts 410. As part of the training and the subsequent routing determination, the prediction system 100 may normalize the tokens prior to providing the tokens to the gating network 400. Normalizing the tokens can facilitate stabilizing the training of the gating network 400, thereby providing more efficient and accurate training. In various configurations, the prediction system 100 continues to normalize the tokens during inference when providing the inputs to the gating network 400 to determine the routing. In this way, the MoE layer 400 processes the inputs in a more efficient manner by utilizing only a subset of the experts to generate a feature vector that represents features within the seasonal component and the trend component.

Returning to FIG. 3, the output of the MoE layer 325 in the encoder 305 is concatenated with the input and provided to an additional series decomposition block 320 in order to again decompose the intermediate result of the encoder 305. The output of the encoder 305 is then provided into the decoder 310. The output of the encoder 305 includes past seasonal information and is, for example, used by the decoder 310 as cross information (e.g., cross-attention). The decoder 310 is formed from two parts that include an accumulation structure for trend-cyclical components and a stacked auto-correlation mechanism for the seasonal components. As shown, the arrangement of the auto-correlation blocks 315, the decomposition blocks 320 and the MoE layer 325 in the decoder form the stacked autocorrelation mechanism. Separately, the concatenation blocks 330, which combine the identified values form the accumulation structure.

The stacked auto-correlation mechanism operates to refine the prediction and utilize past seasonal information. In general, the decoder 310 extracts potential trends from the intermediate hidden variables allowing the model 160 to progressively refine the trend prediction and eliminate interference information for period-based dependency discovery in auto-correlation. Investigating the structure of the decoder 310 further, the decoder 310 includes an auto-correlation block 315 and a series decomposition block 320 prior to the input from the encoder 305. This portion of the decoder 310 is referred to as the initialization block and accepts a seasonal initialization component that the decoder module 130 forms from a portion of the input data 150 by appending placeholders of a predefined length that are filled with scalars to the input data 150 for a horizon defined by, for example, the prediction. Thus, the autocorrelation block and the series decomposition block process the seasonal initialization into a query value that is provided together with a key and a value from the encoder 305 into a subsequent autocorrelation block 315.

In parallel, the trend-cyclical initialization component, which is formed in a similar manner as the seasonal initialization component, is accumulated with intermediate outputs of each separate stage of the decoder 310 via the concatenation blocks 330. The subsequent combination of functional blocks (e.g., 315, 320, 325, 320) then act to refine the determination of the seasonal component until concatenating the result with the accumulated trend component to form the prediction. In this way, the model 160 is able to improve the determination of the RUL from the time-series data.

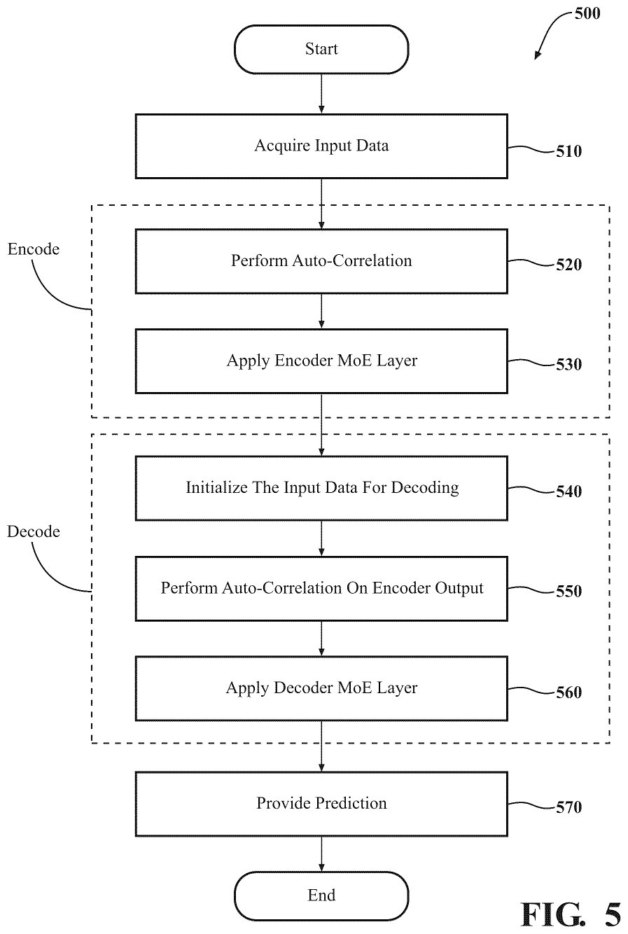

Additional aspects of the prediction system 100 will be discussed in relation to FIG. 5. FIG. 5 illustrates a flowchart of a method 500 that is associated with improving predictions from time-series data using a transformer-based model that includes MoE layers and further uses autocorrelation. Method 500 will be discussed from the perspective of the prediction system 100 of FIGS. 1, and 2. While method 500 is discussed in combination with the prediction system 100, it should be appreciated that the method 500 is not limited to being implemented within the prediction system 100 but is instead one example of a system that may implement the method 500.

At 510, the encoder module 120 acquires the input data 150 about operating characteristics of a device (e.g., a battery). As previously described, the input data 150 may be comprised of various pieces of information depending on, for example, availability. That is, in general, the input data 150 includes at least data from which the capacity can be derived. In one arrangement, the input data 150 includes voltage and current data over a defined number of prior cycles of the battery that is sensed at, for example, an output of the battery. The number of prior cycles of the battery may be dynamically selected according to, for example, an extent of information that is available. Otherwise, the encoder module 120 uses a predefined number of cycles. Moreover, the particular pieces of information that comprise the input data 150 may vary according to implementation. For example, in further approaches, the input data 150 may include different or added elements, such as readings at individual battery cells in a battery pack, internal resistances, temperatures, and so on. In any case, the input data 150 uses N predefined cycles, which may include, for example, 10, 25, 50, or another selection of cycles.

At 520, the encoder module 120 begins the encoding of the input data 150. In particular, the encoder module 120 applies an encoder portion of the model 160 to the input data 150. Initially, the encoder module 120 applies an autocorrelation function to the input data 150. In various implementations, the autocorrelation function may include a Fast-Fourier Transform (FFT). In any case, the autocorrelation determines period-based dependencies by calculating a series autocorrelation and aggregating similar sub-series by time delay aggregation.

Moreover, as part of the autocorrelation at 520, the encoder module 120 may perform additional functions, such as concatenating the output of the autocorrelation with the original input and then performing a series decomposition on the combined output. As previously mentioned, the series decomposition functions to decompose the input into a seasonal component and a trend component, which are provided into subsequent aspects of the encoder pipeline.

At 530, the encoder module 120 uses an encoder MoE layer of the encoder to derive feature dependencies, which are output as a feature vector. The MoE layer generally compresses the seasonal component and the trend component into a combined output that is the feature vector. Accordingly, in addition to the encoder module 120 applying the MoE layer at 530, the encoder module 120 may further concatenate the input to the MoE layer with the output and then apply a series decomposition to the concatenated output in order to again decompose the feature vector into the seasonal and trend components. Thus, the resulting output of the encoder module 120 may take the form of key components, value components, and query components, which are projections of the trend and seasonal components.

At 540, the decoder module 130 begins decoding the output from the encoder by initializing the decoding via constructing initialization data. For example, the decoder module 130, in at least one approach, uses a portion of the original input data 150 as a seed within a seasonal initialization component and a trend initialization component to form a first portion thereof. The decoder module 130 then uses placeholders for a second portion that may be populated with scalars having a zero value or a mean value. The placeholders generally extend out to a prediction horizon to which the prediction is to be generated. Moreover, the initialization data is processed separately by different pipelines in the decoder. The decoder module 130 auto-correlates the seasonal initialization component, combines the autocorrelated output with the seasonal initialization component, and then further performs a series decomposition on the combined output. The decoder module 130 then accumulates the decomposed result of the initialization of the seasonal component with the trend initialization component.

At 550, the decoder module 130 auto-correlates a portion of the output from the encoder with a portion of the decomposed result of the initialization of the seasonal component. For example, in one approach, the decoder module 130 auto-correlates a key (K) and a value (V) from the encoder output with an initialization query (Q) from the seasonal initialization component. The decoder module 130 further concatenates the query (Q) with the output of the autocorrelation before performing a series decomposition on the concatenated result. The decoder module 130 then passes the decomposed result to a decoder MoE layer and also concatenates the intermediate prediction with the accumulated trend component.

At 560, the decoder module 130 applies the decoder MoE layer to the decomposed result of the prior autocorrelation function. The decoder module 130 then concatenates the output of the MoE layer with the input of the MoE layer and again processes the concatenated output by performing a series decomposition. The decoder module 130 then accumulates the decomposed output with the previously accumulated trend component and further concatenates the accumulated trend component with the output of the decomposition to generate the prediction.

At 560, the decoder module 130 provides the prediction. In one approach, the decoder module 130 provides the prediction as a RUL in a communication to, for example, a driver of an associated vehicle and/or a remote service. For example, the communication to the driver may be an in-vehicle alert that specifies the condition of the battery. The alert may be a simple indication of a problem or may provide more detailed information, such as specifying to the driver to adapt use of the vehicle according to the degradation (e.g., limit certain behaviors, such as extended trips, quick acceleration, high speeds, etc.). The alert to the driver may further specify the RUL, thereby indicating how long the battery will likely remain functional. The alert may be audio, visual, haptic, etc. Thus, the decoder module 130 may control various systems of the vehicle 600, such as displays, to provide the alert. In an instance where the decoder module 130 communicates the RUL to a remote service, the communication can be an alert to schedule service and order a replacement for the device. Thus, the communication may be provided to a dealership or other associated repair/service center that then correlates with the driver to service the vehicle 600. In yet a further embodiment, the decoder module 130 may adapt the operation of the vehicle by, for example, limiting functionality (e.g., limiting charging rates, etc.) of the vehicle. In this way, the prediction system 100 functions to improve determinations about the health of the battery and facilitate mitigation of failure and servicing of such components.

It should be appreciated that while the model 160 is described in relation to the remaining useful life (RUL) of a battery. In further arrangements, the prediction system 100 may instead be configured to predict the RUL for other devices, such as vehicle components (e.g., electronics), and so on. Moreover, beyond the determination of a RUL, the prediction system 100 can be configured to predict other time-dependent elements, such as the trajectory of objects, etc. In this way, the prediction system 100 is able to improve inferences for time-series data using the model 160, as described.

Referring to FIG. 6, an example of a vehicle 600 is illustrated. As used herein, a “vehicle” is any form of transport that may be motorized or otherwise powered. In one or more implementations, the vehicle 600 is an automobile. While arrangements will be described herein with respect to automobiles, it will be understood that embodiments are not limited to automobiles. In some implementations, the vehicle 600 may be a robotic device or a form of transport that, for example, includes sensors to perceive aspects of the surrounding environment and thus benefits from the functionality discussed herein.

The vehicle 600 also includes various elements. It will be understood that in various embodiments it may not be necessary for the vehicle 600 to have all of the elements shown in FIG. 6. The vehicle 600 can have different combinations of the various elements shown in FIG. 6. Further, the vehicle 600 can have additional elements to those shown in FIG. 6. In some arrangements, the vehicle 600 may be implemented without one or more of the elements shown in FIG. 6. While the various elements are shown as being located within the vehicle 600 in FIG. 6, it will be understood that one or more of these elements can be located external to the vehicle 600. Further, the elements shown may be physically separated by large distances. For example, as discussed, one or more components of the disclosed system can be implemented within a vehicle while further components of the system are implemented within a cloud-computing environment or other system that is remote from the vehicle 600.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 600 includes a prediction system 100 that is implemented to perform methods and other functions as disclosed herein relating to improving mapping through synthesizing probe data.

FIG. 6 will now be discussed in full detail as an example environment within which the system and methods disclosed herein may operate. In some instances, the vehicle 600 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 600 as manipulated by a user (e.g., human driver). In one or more arrangements, the vehicle 600 can be a manually-controlled vehicle that is configured to operate in only the manual mode.

In one or more arrangements, the vehicle 600 implements some level of automation in order to operate autonomously or semi-autonomously. As used herein, automated control of the vehicle 600 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 600 along a travel route via a computing system to control the vehicle 600 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 600.

With continued reference to the various components illustrated in FIG. 6, the vehicle 600 includes one or more processors 610. In one or more arrangements, the processor(s) 610 can be a primary/centralized processor of the vehicle 600 or may be representative of many distributed processing units. For instance, the processor(s) 610 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 600.

The vehicle 600 can include one or more data stores 615 for storing one or more types of data. The data store 615 can be comprised of volatile and/or non-volatile memory. Examples of memory that may form the data store 615 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 615 is a component of the processor(s) 610. In general, the data store 615 is operatively connected to the processor(s) 610 for use thereby. The term “operatively connected,” as used throughout this description, can include direct or indirect connections, including connections without direct physical contact.

In one or more arrangements, the one or more data stores 615 include various data elements to support functions of the vehicle 600, such as semi-autonomous and/or autonomous functions. Thus, the data store 615 may store map data 616 and/or sensor data 619. The map data 616 includes, in at least one approach, maps of one or more geographic areas. In some instances, the map data 616 can include information about roads (e.g., lane and/or road maps), traffic control devices, road markings, structures, features, and/or landmarks in the one or more geographic areas. The map data 616 may be characterized, in at least one approach, as a high-definition (HD) map that provides information for autonomous and/or semi-autonomous functions.

In one or more arrangements, the map data 616 can include one or more terrain maps 617. The terrain map(s) 617 can include information about the ground, terrain, roads, surfaces, and/or other features of one or more geographic areas. The terrain map(s) 617 can include elevation data in the one or more geographic areas. In one or more arrangements, the map data 616 includes one or more static obstacle maps 618. The static obstacle map(s) 618 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 619 is data provided from one or more sensors of the sensor system 620. Thus, the sensor data 619 may include observations of a surrounding environment of the vehicle 600 and/or information about the vehicle 600 itself. In some instances, one or more data stores 615 located onboard the vehicle 600 store at least a portion of the map data 616 and/or the sensor data 619. Alternatively, or in addition, at least a portion of the map data 616 and/or the sensor data 619 can be located in one or more data stores 615 that are located remotely from the vehicle 600.

As noted above, the vehicle 600 can include the sensor system 620. The sensor system 620 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 620 and/or the one or more sensors can be operatively connected to the processor(s) 610, the data store(s) 615, and/or another element of the vehicle 600.

Various examples of different types of sensors will be described herein. However, it will be understood that the embodiments are not limited to the particular sensors described. In various configurations, the sensor system 620 includes one or more vehicle sensors 621 and/or one or more environment sensors. The vehicle sensor(s) 621 function to sense information about the vehicle 600 itself. In one or more arrangements, the vehicle sensor(s) 621 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 600.

As noted, the sensor system 620 can include one or more environment sensors 622 that sense a surrounding environment (e.g., external) of the vehicle 600 and/or, in at least one arrangement, an environment of a passenger cabin of the vehicle 600. For example, the one or more environment sensors 622 sense objects the surrounding environment of the vehicle 600. Such obstacles may be stationary objects and/or dynamic objects. Various examples of sensors of the sensor system 620 will be described herein. The example sensors may be part of the one or more environment sensors 622 and/or the one or more vehicle sensors 621. However, it will be understood that the embodiments are not limited to the particular sensors described. As an example, in one or more arrangements, the sensor system 620 includes one or more radar sensors 623, one or more LIDAR sensors 624, one or more sonar sensors 625 (e.g., ultrasonic sensors), and/or one or more cameras 626 (e.g., monocular, stereoscopic, RGB, infrared, etc.).

Continuing with the discussion of elements from FIG. 6, the vehicle 600 can include an input system 630. The input system 630 generally encompasses one or more devices that enable the acquisition of information by a machine from an outside source, such as an operator. The input system 630 can receive an input from a vehicle passenger (e.g., a driver/operator and/or a passenger). Additionally, in at least one configuration, the vehicle 600 includes an output system 635. The output system 635 includes, for example, one or more devices that enable information/data to be provided to external targets (e.g., a person, a vehicle passenger, another vehicle, another electronic device, etc.).

Furthermore, the vehicle 600 includes, in various arrangements, one or more vehicle systems 640. Various examples of the one or more vehicle systems 640 are shown in FIG. 6. However, the vehicle 600 can include a different arrangement of vehicle systems. It should be appreciated that although particular vehicle systems are separately defined, each or any of the systems or portions thereof may be otherwise combined or segregated via hardware and/or software within the vehicle 600. As illustrated, the vehicle 600 includes a propulsion system 641, a braking system 642, a steering system 643, a throttle system 644, a transmission system 645, a signaling system 646, and a navigation system 647.

The navigation system 647 can include one or more devices, applications, and/or combinations thereof to determine the geographic location of the vehicle 600 and/or to determine a travel route for the vehicle 600. The navigation system 647 can include one or more mapping applications to determine a travel route for the vehicle 600 according to, for example, the map data 616. The navigation system 647 may include or at least provide connection to a global positioning system, a local positioning system or a geolocation system.

In one or more configurations, the vehicle systems 640 function cooperatively with other components of the vehicle 600. For example, the processor(s) 610, the prediction system 100, and/or automated driving module(s) 660 can be operatively connected to communicate with the various vehicle systems 640 and/or individual components thereof. For example, the processor(s) 610 and/or the automated driving module(s) 660 can be in communication to send and/or receive information from the various vehicle systems 640 to control the navigation and/or maneuvering of the vehicle 600. The processor(s) 610, the prediction system 100, and/or the automated driving module(s) 660 may control some or all of these vehicle systems 640.

For example, when operating in the autonomous mode, the processor(s) 610, the prediction system 100, and/or the automated driving module(s) 660 control the heading and speed of the vehicle 600. The processor(s) 610, the prediction system 100, and/or the automated driving module(s) 660 cause the vehicle 600 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 600 includes one or more actuators 650 in at least one configuration. The actuators 650 are, for example, elements operable to move and/or control a mechanism, such as one or more of the vehicle systems 640 or components thereof responsive to electronic signals or other inputs from the processor(s) 610 and/or the automated driving module(s) 660. The one or more actuators 650 may include motors, pneumatic actuators, hydraulic pistons, relays, solenoids, piezoelectric actuators, and/or another form of actuator that generates the desired control.

As described previously, the vehicle 600 can include one or more modules, at least some of which are described herein. In at least one arrangement, the modules are implemented as non-transitory computer-readable instructions that, when executed by the processor 610, implement one or more of the various functions described herein. In various arrangements, one or more of the modules are a component of the processor(s) 610, or one or more of the modules are executed on and/or distributed among other processing systems to which the processor(s) 610 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 600 may include one or more automated driving modules 660. The automated driving module(s) 660, in at least one approach, receive data from the sensor system 620 and/or other systems associated with the vehicle 600. In one or more arrangements, the automated driving module(s) 660 use such data to perceive a surrounding environment of the vehicle. The automated driving module(s) 660 determine a position of the vehicle 600 in the surrounding environment and map aspects of the surrounding environment. For example, the automated driving module(s) 660 determines the location of obstacles or other environmental features including traffic signs, trees, shrubs, neighboring vehicles, pedestrians, etc.

The automated driving module(s) 660 either independently or in combination with the prediction system 100 can be configured to determine travel path(s), current autonomous driving maneuvers for the vehicle 600, future autonomous driving maneuvers and/or modifications to current autonomous driving maneuvers based on data acquired by the sensor system 620 and/or another source. In general, the automated driving module(s) 660 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. The phrase “computer-readable storage medium” means a non-transitory storage medium. A computer-readable storage medium may be, for example, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system or device.

Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system, comprising:
one or more processors;
a memory communicably coupled to the one or more processors and storing instructions that, when executed by the one or more processors, cause the one or more processors to:
acquire input data about operating characteristics of a device, the input data being time-series data;
encode the input data by i) autocorrelating the input data and ii) applying an encoder mixture of experts (MoE) layer to generate a feature vector;
decode the feature vector by i) autocorrelating the feature vector with an initialization query and ii) applying a decoder MoE layer to generate a prediction; and
provide the prediction about the device.

2. The prediction system of claim 1, wherein the instructions to encode the input data include instructions to decompose the input data into a seasonal component and a trend component prior to and after applying the encoder MoE layer, and
wherein the encoder MoE layer compresses the seasonal component and the trend component into a combined output that is a feature vector.

3. The prediction system of claim 1, wherein the instructions to encode the input data include instructions to output a feature vector including at least key components and value components according to a projection.

4. The prediction system of claim 1, wherein the instructions to decode the feature vector include instructions to initialize a decoder that performs the decoding by autocorrelating and decomposing a seasonal initialization component of the input data, and
wherein the seasonal initialization component includes a seasonal component of the input data appended with placeholders for a future time associated with the prediction having a zero value.

5. The prediction system of claim 1, wherein the encoder MoE layer and the decoder MoE layer include a gating network that routes input tokens to separate experts to derive feature dependencies output as a feature vector.

6. The prediction system of claim 1, wherein the instructions to autocorrelate include instructions to determine period-based dependencies by calculating a series autocorrelation and aggregating similar sub-series by time delay aggregation.

7. The prediction system of claim 1, wherein the input data includes a capacity of a battery that is the device and the prediction indicates a remaining useful life (RUL) of the battery.

8. The prediction system of claim 1, wherein the instructions to decode the feature vector include instructions to accumulate a trend initialization component with intermediate predictions of the decoding, and
wherein trend initialization component includes a trend component of the input data appended with placeholders for a future time having a mean value of the trend component.

9. A non-transitory computer-readable medium including instructions that, when executed by one or more processors, cause the one or more processors to:
acquire input data about operating characteristics of a device, the input data being time-series data;
encode the input data by i) autocorrelating the input data and ii) applying an encoder mixture of experts (MoE) layer to generate a feature vector;
decode the feature vector by i) autocorrelating the feature vector with an initialization query and ii) applying a decoder MoE layer to generate a prediction; and
provide the prediction about the device.

10. The non-transitory computer-readable medium of claim 9, wherein the instructions to encode the input data include instructions to decompose the input data into a seasonal component and a trend component prior to and after applying the encoder MoE layer, and
wherein the encoder MoE layer compresses the seasonal component and the trend component into a combined output that is a feature vector.

11. The non-transitory computer-readable medium of claim 9, wherein the instructions to encode the input data include instructions to output a feature vector including at least key components and value components according to a projection.

12. The non-transitory computer-readable medium of claim 9, wherein the instructions to decode the feature vector include instructions to initialize a decoder that performs the decoding by autocorrelating and decomposing a seasonal initialization component of the input data, and
wherein the seasonal initialization component includes a seasonal component of the input data appended with placeholders for a future time associated with the prediction having a zero value.

13. The non-transitory computer-readable medium of claim 9, wherein the encoder MoE layer and the decoder MoE layer include a gating network that routes input tokens to separate experts to derive feature dependencies output as a feature vector.

14. A method, comprising:
acquiring input data about operating characteristics of a device, the input data being time-series data;
encoding the input data by i) autocorrelating the input data and ii) applying an encoder mixture of experts (MoE) layer to generate a feature vector;
decoding the feature vector by i) autocorrelating the feature vector with an initialization query and ii) applying a decoder MoE layer to generate a prediction; and
providing the prediction.

15. The method of claim 14, wherein encoding the input data includes decomposing the input data into a seasonal component and a trend component prior to and after applying the encoder MoE layer, and
wherein the encoder MoE layer compresses the seasonal component and the trend component into a combined output that is a feature vector.

16. The method of claim 14, wherein encoding the input data outputs a feature vector including at least key components and value components according to a projection.

17. The method of claim 14, wherein decoding the feature vector includes initializing the decoding by autocorrelating and decomposing a seasonal initialization component of the input data and accumulating a trend initialization component with intermediate predictions of the decoding,
wherein the seasonal initialization component includes a seasonal component of the input data appended with placeholders for a future time associated with the prediction having a zero value, and
wherein trend initialization component includes a trend component of the input data appended with placeholders for the future time having a mean value of the trend component.

18. The method of claim 14, wherein the encoder MoE layer and the decoder MoE layer include a gating network that routes input tokens to separate experts to derive feature dependencies output as a feature vector.

19. The method of claim 14, wherein autocorrelating includes determining period-based dependencies by calculating a series autocorrelation and aggregating similar sub-series by time delay aggregation.

20. The method of claim 14, wherein the input data includes a capacity of a battery and the prediction indicates a remaining useful life (RUL) of the battery.
